(19) United States
(12) Patent Application Publication
(10) Pub. No.: US 2023/0033718 A1
(43) Pub. Date: Feb. 2, 2023

(54) OPTICAL DEVICE, METHOD AND USE

(71) Applicants: Surfunction GmbH, Saarbruecken (DE); DLIP UG, Saarlouis (DE)

(72) Inventors: Bogdan VOISIAT, Dresden (DE); Andrés Fabián LASAGNI, Grumbach (DE)

(73) Assignees: Surfunction GmbH, Saarbruecken (DE); DLIP UG, Saarlouis (DE)

(21) Appl. No.: 17/962,271

(22) Filed: Oct. 7, 2022

Related U.S. Application Data
(63) Continuation of application No. PCT/EP2021/059422, filed on Apr. 12, 2021.

(30) Foreign Application Priority Data
Apr. 11, 2020 (DE) 10 2020 204 656.5

(51) Int. Cl. B23K 26/06; G02B 27/09

(52) U.S. Cl. CPC B23K 26/0648; G02B 27/0966; G02B 27/0972; B23K 26/0652; G02B 27/1093

(57) ABSTRACT

An optical device, its use, and a method for interference structuring of a sample. A laser emits a laser beam that is split into at least two partial beams by a beam splitter. A first cylindrical lens and a second cylindrical lens for refracting the partial beams into an interference area are arranged in the beam path. The partial beams interfere in such a way that a structure having linear structure elements may be formed in a structural region of the sample. The cylinder axis of the first cylindrical lens is aligned parallel to the cylinder axis of the second cylindrical lens.

This nonprovisional application is a continuation of International Application No. PCT/EP2021/059422, which was filed on Apr. 12, 2021, and which claims priority to German Patent Application No. 10 2020 204 656.5, which was filed in Germany on Apr. 11, 2020, and which are both herein incorporated by reference.

### BACKGROUND OF THE INVENTION

### Field of the Invention

The present invention relates to an optical device, a method, and a use of the optical device for interference structuring of a sample.

### Description of the Background Art

Within the meaning of the invention, samples are, for example, components that are built into more complex components and are to be provided with a relatively extensive structure in the course of their processing. In terms of productivity, it is desirable to form the structuring over a large area and in the shortest possible time.

For this purpose, it is known to provide the structuring of the sample by means of interference structuring, a laser beam being split into two partial beams which interfere with one another by means of further optical components in a structural region of the sample, the structuring of the sample being formed as a result of the spatial interferometric energy distribution of the mutually interfering partial beams. Such a known device is disclosed, for example, in EP 2 596 899 A2 (which corresponds to US 2013/0153553), whereby structures having linear structure elements may be formed in particular. Because of the large number of optical elements, the known device is expensive and prone to incorrect adjustments. A particularly high level of effort must be expended in shaping and deflecting the individual partial beams, and the angles for the deflection of the partial beams must be maintained very precisely. This is particularly complicated if parameters are to be changed during processing in order to specifically influence changes to individual structures or structure elements. In addition, the difference in the path lengths covered by the partial beams is large enough that the coherence length of the laser radiation is exceeded, particularly in the case of pulsed laser radiation with short or even ultra-short pulse durations, so that there is no interference between the partial beams and thus no structuring of the sample.

However, the known device is therefore particularly unsuitable for ultra-short laser pulses, the pulse durations of which are in the femtosecond and/or picosecond range.

### SUMMARY OF THE INVENTION

It is therefore an object of the present invention to provide an improved device which, while eliminating the disadvantages of the prior art, enables more efficient interference structuring of the sample, and, in particular, offers simplified and cheaper handling and, in particular, enables interference structuring of the sample with short pulse durations. The same applies to the method and use.

The object of the invention is achieved, in an example, by an optical device for interference structuring of a sample comprising a laser for emitting a laser beam, a beam splitter for splitting the laser beam into at least two partial beams, at least one first cylindrical lens, at least one second cylindrical lens for refracting the at least two partial beams in the direction of an interference region, the beam splitter, the at least one first cylindrical lens, and the at least one second cylindrical lens being arranged in the beam path of the laser beam such that the at least two partial beams of the laser beam interfere with one another in the interference region such that a structure having linear structure elements may be formed in the structural region of the sample, with the cylinder axis of the at least one first cylindrical lens being aligned parallel to the cylinder axis of the at least one second cylindrical lens.

The object of the invention is also achieved, in an example, by a method for interference structuring of a sample comprising the following steps: providing a laser for emitting a laser beam, splitting the laser beam into at least two partial beams, arranging at least one first cylindrical lens, arranging at least one second cylindrical lens such that the at least two partial beams are refracted in the direction of an interference region such that the at least two partial beams of the laser beam interfere with one another in the interference region such that a structure with linear structure elements may be formed in a structural region of the sample, and alignment of the cylinder axis of the at least one first cylindrical lens parallel to the cylinder axis of the at least one second cylindrical lens.

In addition, the object of the invention is achieved, in an example, by using a device according to the invention for interference structuring of a sample, in particular a component.

The invention is based on the basic idea that the alignment according to the invention of the cylinder axes of the at least one first and the at least one second cylindrical lens enables targeted manipulation of the laser beam, including its partial beams, in a first plane that includes the optical axis and is arranged normal to the cylinder axis of the at least one first cylindrical lens without affecting the beam path of the laser beam in a second plane, which is arranged perpendicularly to the first plane. In this way, the interference structuring of the sample may be influenced in a particularly simple and efficient manner. The handling of the device according to the invention is thus significantly simplified compared to the known devices. The same applies to the method according to the invention and the use according to the invention. Another advantage of the device according to the invention results from the fact that the path difference of the partial beams is relatively small. Therefore, the coherence length of the laser radiation is not exceeded, so that, in particular in the case of laser radiation with short and/or ultra-short laser pulses, there is an interference of the partial beams, so an interference structuring of the samples is possible. The device according to the invention is therefore particularly suitable for laser radiation with short pulse durations.

For the purposes of the invention, interference structuring may refer to the structuring of the sample by means of the interference of at least two laser beams. The spatial energy distribution that forms as a result of the interference of the partial beams interacts with the sample material in such a way that the structuring of the sample is carried out in accordance with the energy distribution of the interference structure. In particular, the sample may be structured with line-shaped structure elements that are arranged in a structure period. In this respect, interference structuring includes both material removal from the sample, for example by means of ablation, and targeted alteration of the sample material, for example by photopolymerization. In addition, the interference structuring may result in targeted remelting and/or a targeted alteration of the chemical composition and/or an alteration of the (crystalline) structure of the sample material. For the purposes of the invention, the sample is structured, for example, on the sample surface and/or within the sample volume, the sample in particular being lithographically machinable by interference structuring, which is also referred to as interference lithography. The structuring of the sample serves in particular to provide the sample with a technical function, an aesthetic impression, and/or a marking. Within the meaning of the invention, “upstream” designates a direction counter to the propagation direction of the laser beam, which direction is thus facing the laser. Correspondingly, “downstream” designates a direction away from the laser.

The laser may be designed as a diode-pumped solid-state laser and in particular emit pulsed laser radiation, the laser pulses having a temporal pulse duration in the femtosecond, picosecond, and/or nanosecond range and wavelengths in the UV, VIS, and/or IR range. It is known that laser pulses having a pulse duration in the femtosecond and/or picosecond range are referred to as ultra-short pulses. The pulse duration of the laser pulses is preferably between 10 fs and 10 ms. The laser preferably emits collimated laser radiation which is in particular aligned parallel to the optical axis.

The beam splitter can be designed as a diffractive optical element, in particular as a grating. Alternatively, the beam splitter may be designed as a prism or, for example, as a semi-transparent mirror. The mirror is preferably designed as a partially reflecting mirror. The at least two partial beams are in particular arranged in a common plane, which includes the optical axis, and which is arranged normal to the cylinder axis of the at least one first cylindrical lens. For a simple configuration of the device, at least two partial beams may each have a propagation direction that is arranged at the same angle to the optical axis. In one embodiment of the invention, the at least two partial beams are divided evenly in terms of intensity, so that, for example, the intensity of the first partial beam is substantially the same as the intensity of the second partial beam.

For the purposes of the invention, the interference angle denotes the angle at which a partial beam is refracted toward the interference region relative to the optical axis after the at least one second cylindrical lens. Because the partial beams in the first and second plane may be manipulated independently of one another according to the invention, the interference angle may refer to the first plane, for example the yz plane, and/or to the second plane, for example the xz plane. The interference angle may be variable in order to change the structure period of the interference pattern. For this purpose, the beam splitter is preferably movable in translation parallel to the optical axis.

The at least one first cylindrical lens may be designed as a converging lens having at least one convex surface and/or may be arranged upstream or downstream of the beam splitter. In addition, the at least one first cylindrical lens may be movable in translation parallel to the optical axis.

The at least one second cylindrical lens is preferably arranged in such a way that the partial beams are refracted toward the interference region, in which region the partial beams interfere with one another, and said lens is preferably designed as a converging lens having at least one convex surface. The focal length of the at least one second cylindrical lens is preferably smaller than the focal length of the at least one first cylindrical lens, so that the largest possible interference angle may be set. For improved adjustment of the device according to the invention, the at least one second cylindrical lens is preferably movable in translation parallel to the optical axis.

The distance between the at least one first cylindrical lens and the at least one second cylindrical lens is preferably at least or at most, in particular substantially, the sum of the two focal lengths. As a result, the partial beams may each be focused into focal points that are actually located in front of the second cylindrical lens or virtually behind it. The path difference of the partial beams is in particular so small that interference of the partial beams is done in terms of volume, so that the interference region is three-dimensional, i.e., in particular has an extension in the direction of the optical axis. In this way, the sample may be structured in terms of volume, particularly when using ultra-short pulse lengths. The focal points of all partial beams preferably lie within a common focal point plane, which may be oriented normal to the optical axis. In a further embodiment of the invention, the convex surfaces of the first and second cylindrical lenses face one another and/or planar surfaces of the first and second cylindrical lenses face away from one another.

At least one third cylindrical lens can be provided as a converging lens, the cylinder axis of which is aligned perpendicularly to the cylinder axis of the at least one first cylindrical lens and in particular perpendicularly to the optical axis, so that the at least one third cylindrical lens can influence the beam path in the second plane independently of the first plane. In a particularly simple embodiment of the invention, the at least one third cylindrical lens is arranged upstream or downstream of the beam splitter. The distance between the interference region and the at least one third cylindrical lens preferably corresponds to its focal length, so that the laser beam, including its partial beams, is focused on the interference region in the second plane. Alternatively, the distance of the interference region from the at least one third cylindrical lens is larger or smaller than its focal length. The extension of the interference pattern perpendicular to the cylinder axis of the at least one third cylindrical lens may be changed by moving the at least one third cylindrical lens in translation parallel to the optical axis.

At least one fourth cylindrical lens can be provided as a diverging lens, the cylinder axis of which is arranged in particular parallel to the cylinder axis of the at least one first cylindrical lens. The at least one fourth cylindrical lens may be arranged downstream of the beam splitter and/or of the at least one first cylindrical lens, but preferably upstream of all focal points of the partial beams. The at least one fourth cylindrical lens may be movable in translation, in particular parallel to the optical axis. In addition, the at least one fourth cylindrical lens may be movable in rotation about its cylinder axis. In a particularly advantageous embodiment of the invention, each partial beam is assigned exactly one fourth cylindrical lens, it being possible for the fourth cylindrical lenses to be movable in rotation about their respective cylinder axes. For the individual adjustment of each partial beam, in particular at least two fourth cylindrical lenses are movable independently of one another, alternatively or additionally at least two fourth cylindrical lenses being movable synchronously with one another for the purpose of a simplified adjustment. The at least one fourth cylindrical lens may be arranged in such a way that at least one partial beam is collimated after the fourth cylindrical lens. The at least one fourth cylindrical lens preferably forms a lens system having the at least one first cylindrical lens and having the at least one second cylindrical lens, which system is movable overall parallel to the optical axis, the positions of the components of the lens system being able to remain constant relative to one another along the optical axis.

At least one fifth cylindrical lens may be provided as a converging lens, the cylinder axis of which is aligned parallel to the cylinder axis of the at least one first cylindrical lens, and which, in particular together with the at least one first cylindrical lens, forms a lens system, so that optical errors of the first cylindrical lens may be corrected by the fifth cylindrical lens. For this purpose, the fifth cylindrical lens is preferably arranged directly adjacent to the at least one first cylindrical lens.

At least one sixth cylindrical lens may be provided as a converging lens, the cylinder axis of which is aligned parallel to the cylinder axis of the at least one first cylindrical lens and which may be arranged upstream of the at least one second cylindrical lens. A convex surface of the at least one sixth cylindrical lens may face the at least one first cylindrical lens. In addition, at least one seventh cylindrical lens may be provided as a diverging lens, the cylinder axis of which is aligned parallel to the cylinder axis of the at least one first cylindrical lens and which may be arranged upstream of the at least one second cylindrical lens. The at least one seventh cylindrical lens together with the at least one sixth cylindrical lens and with the at least one second cylindrical lens preferably forms a lens system for correcting optical errors. For this purpose, in particular the at least one sixth cylindrical lens and/or the at least one seventh cylindrical lens and/or the at least one second cylindrical lens are movable in translation independently of one another parallel to the optical axis.

A first prism may be provided, a prism axis of which is arranged perpendicularly to the base area and is aligned parallel to the cylinder axis of the at least one first cylindrical lens. In particular, the first prism has a focusing optical effect on the laser beam, including its partial beams. In particular, the first prism has a polygonal base area, which is designed, for example, in the shape of a isosceles triangle. Alternatively, the base area of the at least one prism may be round, in particular elliptical. At least one surface of the at least one first prism may be aligned normal to the optical axis. The at least one first prism is preferably movable in translation parallel to the optical axis and/or is arranged downstream of the at least one first cylindrical lens.

At least one second prism may be provided, the prism axis of which is aligned parallel to the cylinder axis of the at least one first cylindrical lens. For example, the at least one second prism has a diverging optical effect on the laser beam, including its partial beams. In addition, the at least one second prism may have a base area that corresponds to two joined right triangles. The second prism may be movable in translation parallel to the optical axis. In an advantageous embodiment of the invention, the base areas of the first prism and the at least one second prism together correspond to a rectangle. In a particularly preferred embodiment, exactly one second prism is assigned to each partial beam, the base areas of the second prisms in particular corresponding to a right triangle. At least two second prisms may be movable independently of one another, and/or at least two second prisms may be movable synchronously with one another. The at least one first prism and/or the at least one second prism may be arranged between the at least one first cylindrical lens and the at least one second cylindrical lens.

The beam splitter and/or at least one cylindrical lens and/or at least one prism can be movable in translation parallel to the optical axis in order to alter parameters of the interference structure and/or to correct optical errors.

At least one beam expander can be provided to change the beam cross section of the laser beam, including its partial beams, and/or to change the structure period. The beam expander may be designed to change, for example, the interference angle of the partial beams, so that the structure period of the interference pattern is changeable. For example, the at least one beam expander is formed by three cylindrical lenses and/or by a cylindrical lens having a first prism and having at least one second prism. Due to the mobility of at least one of its components, the beam expander is preferably designed as a variable beam expander. Functionally, the beam expander corresponds in particular to a device for optical enlargement of the laser beam, which device enlarges the cross section of the laser beam when the magnification value is greater than 1 and reduces the cross section of the laser beam when the magnification value is between 0 and 1.

The interference pattern can have linear structure elements whose directions of extension are in particular each arranged parallel to the cylinder axis of the first cylindrical lens. In addition, the interference pattern may have a user-defined, in particular variable, structure period in at least one direction, which structure corresponds to the distance between two adjacent structure elements. The interference pattern can be rectangular or elliptical, the interference pattern being able to have a different extension in a first axis, which is aligned parallel to the cylinder axis of the first cylindrical lens, than in a second axis, which is arranged perpendicular to the cylinder axis of the first cylinder axis. The dimensions of the interference pattern and its structure period are changeable in particular by changing the optical components of the device according to the invention, preferably by changing the position and/or the optical properties. In addition, the spatial position of the interference pattern may be changeable, in particular by means of a movement of the at least one fourth cylindrical lens.

The extension of the interference pattern in a specific direction is changeable in particular by changing at least one of those cylindrical lenses whose cylinder axes are arranged perpendicular to this direction, a change in this sense including a change in focal length and/or a change in position. For example, the expansion of the interference pattern in the y-direction is possible by changing the focal length of at least one of those cylindrical lenses whose cylinder axis is arranged parallel to the x-direction, and vice versa.

A beam shaping device can be provided which is designed such that the cross-sectional profile of the laser beam is variable in a user-defined manner in order to influence the shape of the interference structure, the cross-sectional profile being variable in particular by means of diffraction effects. Particularly preferably, the beam shaping device is designed to form an elliptical or polygonal, in particular rectangular, cross-sectional profile of the laser beam, in particular based on a Gaussian spatial intensity distribution of the cross-sectional profile, said profile also being referred to as a “top hat” or “flat top” profile. The shape of the interference pattern may be changeable by changing the cross-sectional profile of the laser beam, a rectangular cross-sectional profile, for example, which is obtainable, for example, with the beam shaping device already described, causing the interference pattern to have a rectangular shape. The beam shaping device may be designed to be integrated with the beam splitter.

A single first cylindrical lens and/or a single second cylindrical lens may be provided in order to influence all partial beams by means of a single cylindrical lens. In addition, it is possible to replace each cylindrical lens with a lens system in order to correct optical errors. The laser beam, including its partial beams, may be aligned, in particular collimated, at least in portions between the at least one first cylindrical lens and the at least one second cylindrical lens parallel to the optical axis or have a divergence. The size of the partial beam cross-sectional areas in the interference region and, thus, the size of the interference pattern may be influenced by the divergence.

The method according to the invention is preferably carried out using an optical device according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an embodiment of the optical device according to the invention in the yz plane,

FIG. 2 is/shows the embodiment in FIG. 1 in the xz plane,

FIG. 3 shows the interference pattern obtained by the embodiment in FIG. 1,

FIG. 4 is/shows an example of the device according to the invention,

FIG. 5a shows an example of the device according to the invention,

FIG. 5b shows the example in FIG. 5a having a moving beam splitter,

FIG. 6 shows the example in FIG. 5 having a different focal length of the second cylindrical lens,

FIG. 7 is/shows an example of the optical device according to the invention having a third cylindrical lens,

FIG. 8 is/shows the/an interference pattern obtained by the embodiment in FIG. 7,

FIG. 9 is/shows the example in FIG. 7 having a changed position of the third cylindrical lens,

FIG. 10 is/shows another example of the device according to the invention,

FIG. 11a shows a further example of the optical device according to the invention having a fourth cylindrical lens,

FIG. 11b shows the example in FIG. 11a having moving components,

FIG. 12 shows a further example of the optical device according to the invention having two fourth cylindrical lenses and a fifth cylindrical lens,

FIG. 13 is/shows the example in FIG. 12 having moving fourth cylindrical lenses,

FIG. 14a shows a further example of the optical device according to the invention having a sixth and a seventh cylindrical lens,

FIG. 14b shows the example in FIG. 14a having moving components,

FIG. 15a shows a further example of the optical device according to the invention having a fifth and a sixth cylindrical lens,

FIG. 15b shows the example in FIG. 15a having moving components,

FIG. 16a shows a further example of the optical device according to the invention having a first prism,

FIG. 16b shows the example in FIG. 16a having a moving first prism,

FIG. 17 shows a further example of the optical device according to the invention having a second prism,

FIG. 18a shows a further example of the optical device according to the invention having two second prisms,

FIG. 18b shows the example in FIG. 18a having moving prisms,

FIG. 19a shows a further example of the optical device according to the invention having two fourth cylindrical lenses and prisms,

FIG. 19b shows the example in FIG. 19a having moving prisms, and

FIG. 20 shows the example in FIG. 1 having a laser and a sample.

### DETAILED DESCRIPTION

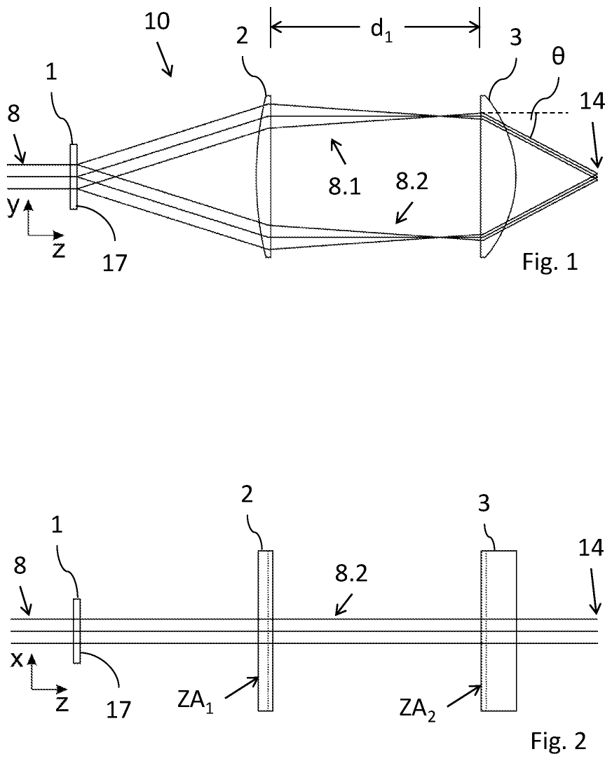

FIG. 1 shows a schematic representation of an embodiment of the optical device 10 according to the invention according to a Cartesian coordinate system in the yz plane, whereby, for the purposes of the invention, the z axis corresponds to the optical axis z, and the x axis and y axis are each arranged perpendicular to the z axis and perpendicular to one another.

A laser 12 emits a laser beam 8, which arrives collimated on a beam splitter 1 and is split into two partial beams 8.1, 8.2, both of which are each deflected at a finite, identical angle to the optical axis z, i.e., axisymmetric thereto, and each continue to be collimated. The beam splitter 1 is designed, for example, as a diffractive optical element in the form of a grating, so that the splitting of the laser beam 8 is due to diffraction effects. Alternatively, the beam splitter 1 may be designed as a partially reflecting mirror. The partial beams 8.1, 8.2 are only deflected in the y-direction; there is no offset of the partial beams 8.1, 8.2 in the x-direction. Downstream of the beam splitter 1, the partial beams 8.1, 8.2 hit a first cylindrical lens 2, the cylinder axis ZA₁ of which is aligned parallel to the x-axis. The surface of the first cylindrical lens 2 facing the beam splitter 1 has a convex design in the yz plane of FIG. 1, while the surface facing away from the beam splitter 1 is flat, so the first cylindrical lens 2 has the shape of a convex-planar converging lens. Due to the first cylindrical lens 2, the two partial beams 8.1, 8.2 each arrive collimated onto it, are each focused on a focal point, the two focal points each being located at the same distance from the first cylindrical lens 2. After passing through the respective focal points, the partial beams 8.1, 8.2 diverge and hit a second, in this case plano-convex cylindrical lens 3, the surface of which facing the beam splitter 1 is planar and the surface facing away from the beam splitter 1 is convex. The cylinder axis ZA₂ of the second cylindrical lens 3 is aligned parallel to the x-axis, so that the cylinder axis ZA₁ of the first cylindrical lens 2 and the cylinder axis ZA₂ of the second cylindrical lens 3 are aligned parallel to one another.

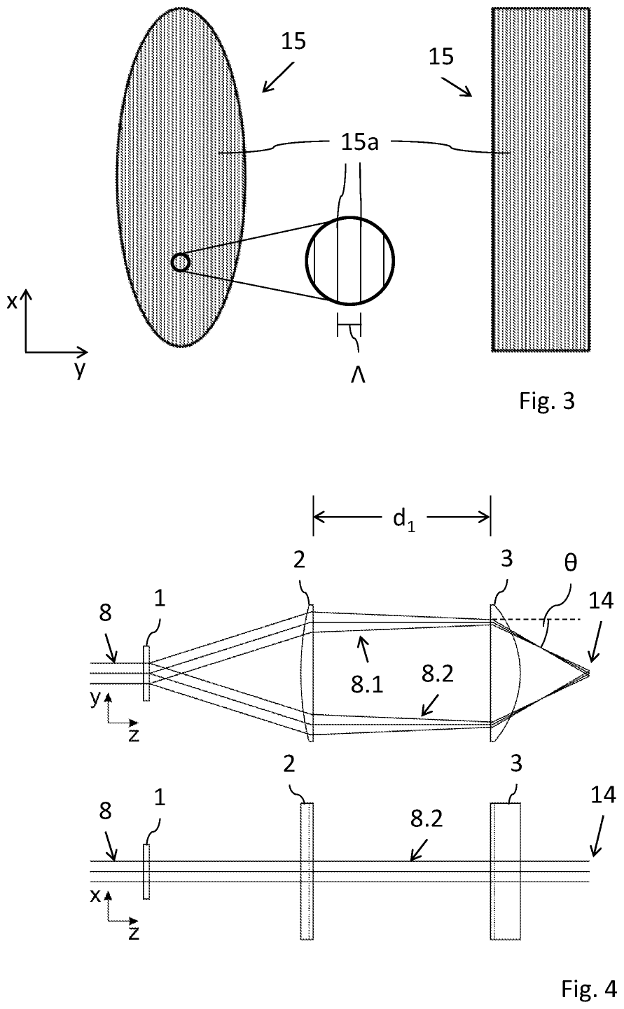

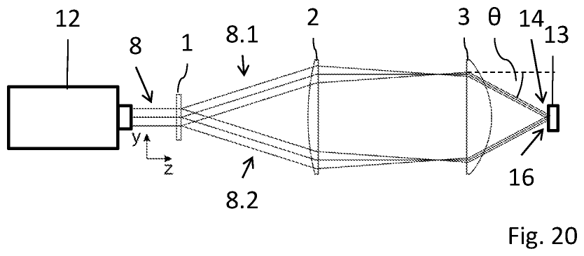

The two partial beams 8.1, 8.2 are each collimated by the second cylindrical lens 3 and directed toward one another at a finite interference angle θ to the optical axis z and in the direction of a sample 13 to be processed such that the partial beams 8.1, 8.2 interfere with one another in an interference region 14 and form an interference pattern 15, the sample 13 being arranged in the interference region 14; see FIG. 20. Due to the spatial energy distribution of the interference pattern 15 and the interaction of the laser radiation with the sample material, the sample 13 is structured in a structural region 16, as shown in reference to the interference pattern 15 in FIG. 3. The structure 9 of the sample 13 is formed by the interference pattern 15 having linear structure elements 15a and a predefined structure period Λ, which will be discussed in more detail below.

FIG. 1 shows that the partial beams 8.1, 8.2 behave symmetrically with respect to the optical axis z. The distance d₁ of the first cylindrical lens 2 from the second cylindrical lens 3 corresponds to the sum of the focal lengths of the two cylindrical lenses 2, 3. Because the cylinder axes ZA₁, ZA₂ of the first and second cylindrical lenses 2, 3 are aligned parallel to one another, the laser beam 8, including its partial beams 8.1, 8.2, may be manipulated in the yz plane independently of the xz plane. The geometry of the structure 9 obtained on the sample 13 may thus be manipulated in the y-axis independently of the x-axis, which is also shown by the following embodiments of the invention. The interference angle θ shown in FIG. 1 refers to the yz plane shown there, in which the previously mentioned splitting of the partial beams 8.1, 8.2 takes place. Due to the focusing of the partial beams 8.1, 8.2 between the first cylindrical lens 2 and the second cylindrical lens 3, the path difference of the partial beams 8.1, 8.2, i.e., the difference in the paths covered by partial beams 8.1, 8.2, is kept as small as possible in order to create an interference region that is spatially as large as possible 14.

FIG. 2 shows the device 10 of FIG. 1 in the xz plane, which is arranged perpendicular to the yz plane of FIG. 1. Due to the nature of the beam splitter 1, the partial beams 8.1, 8.2 of the laser beam 8 are only deflected in the yz plane, as already mentioned, so that the partial beams 8.1, 8.2 overlap in the xz plane and cannot be seen separately there. Because the cylinder axes ZA₁, ZA₂ of the first cylindrical lens 2 and the second cylindrical lens 3 are both aligned parallel to the x-axis, the partial beams 8.1, 8.2 are not refracted by the first cylindrical lens 2 or the second cylindrical lens 3 in the xz plane. The laser beam 8, in particular its partial beams 8.1, 8.2, is collimated in the xz plane and directed onto the interference region 14.

FIG. 3 shows interference patterns 15 obtained by the optical device 10 according to FIG. 1 and FIG. 2 and thus also structures 9 in a structure region 16 of the sample 13 having linear structure elements 15a, which are arranged next to one another in a predefined—in this case fixed—structure period Λ, the linear structure elements 15a being aligned parallel to the y-axis and being arranged adjacent to one another along the x-axis. In the context of the invention, the structure period designates Λ the distance between two adjacent structure elements 15a. The interference pattern 15 arranged on the left in FIG. 3 is elliptical, the semi-axis in the x-direction being larger than the semi-axis in the y-direction. As already mentioned, the structure 9 of the sample 13 is formed by the interference of the partial beams 8.1, 8.2. Depending on the application, a sample surface facing the beam splitter 1 or a sample volume within the sample 13 is processed. Due to the interaction of the laser radiation with the sample material, the sample 13 is processed based on material removal, for example based on ablation processes, and/or based on a modification of the sample material, for example based on polymerization.

In addition to the elliptical interference pattern 15, a rectangular interference pattern 15 shown on the right in FIG. 3, and thus a correspondingly formed structure 9 of the sample 13 may be obtained in that, for example, a beam forming device 17 is used which is integrally formed with the beam splitter 1 and which converts a circular cross section of the incoming laser beam 8 of a typically Gaussian intensity distribution into a rectangular cross section, which cross-section is also referred to as a “top hat” or “flat top” profile. Due to the changed, rectangular cross section of the laser radiation, a rectangular interference pattern 15 results in the interference region 14 and, as stated, effects a corresponding structuring of the sample 13. An enlarged region of the interference pattern 15a is arranged centrally in FIG. 3, from which it may be seen that the structure period Λ corresponds to the distance between two adjacent structure elements 15a.

The embodiment in FIG. 4 corresponds substantially to the embodiment in FIG. 1 and FIG. 2, the focal length of the first cylindrical lens 2 being changed here in such a way that the focal points of the partial beams 8.1, 8.2 are each virtually arranged behind the second cylindrical lens 3 after passing through the first cylindrical lens 2. In particular when fs pulses are used, the path difference of the partial beams may be minimized, thereby causing an interference pattern that is spatially more extensive. A reduction in the distance d₁ between the second cylindrical lens 3 and the first cylindrical lens 2 would have the same effect. The partial beams 8.1, 8.2 are no longer collimated after the second cylindrical lens 3, but are focused on focal points which are each arranged at the same distance between the second cylindrical lens 3 and the interference region 14. After the focal points, the partial beams 8.1, 8.2 each diverge and interfere in the interference region 14 as already described.

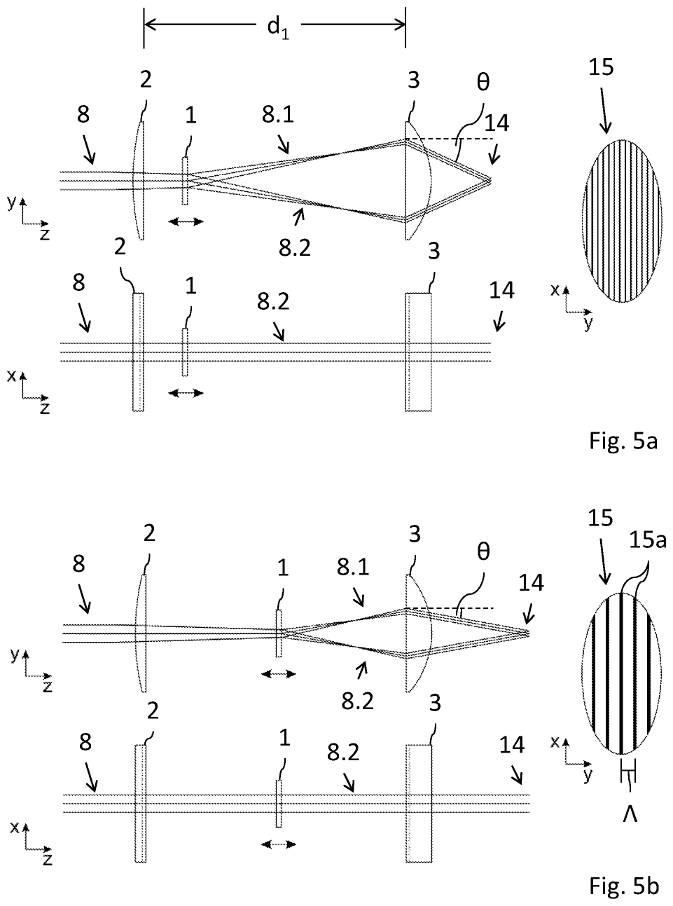

In the embodiment in FIG. 5a, compared to the embodiment in FIG. 1, the beam splitter 1 and the first cylindrical lens 2 are switched in such a way that the laser beam 8 first arrives on the first cylindrical lens 2 and then, due to the optical effect of the first cylindrical lens 1 as a converging lens, is focused on the beam splitter 1. The distance d₁ between the first cylindrical lens 2 and the second cylindrical lens 3 corresponds to the sum of the focal lengths of the two cylindrical lenses 2, 3, so that the partial beams 8.1, 8.2 after the beam splitter 1 are each focused on a focal point in front of the second cylindrical lens 3. After the second cylindrical lens 3, the partial beams 8.1, 8.2, similar to FIG. 1, are each collimated and refracted to the interference region 14. In the embodiment in FIG. 5a, the beam splitter 1 is movable in translation along the optical axis, i.e., in the z-direction, so that a movement of the beam splitter 1 may change the location at which the partial beams 8.1, 8.2 each hit the second cylindrical lens 3, which is shown in FIG. 5b.

Thus, the interference angle θ at which the partial beams 8.1, 8.2 are refracted toward the interference region 14 relative to the optical axis z may also be changed, which affects the structure period Λ of the structure elements 15a. Compared to the interference pattern 15 shown in FIG. 3, the interference pattern 15 shown on the right in FIG. 5a has a larger structure period Λ, because the structure elements 15a are arranged farther away from one another. The mobility of the beam splitter 1 is represented by a double arrow.

In contrast to FIG. 5a, the beam splitter 1 in FIG. 5b was moved parallel to the optical axis z closer to the second cylindrical lens 3. As a result, the partial beams 8.1, 8.2 each hit the second cylindrical lens 3 at a radially smaller distance from the optical axis z. In addition, the partial beams 8.1, 8.2 are refracted toward the interference region 14 by the second cylindrical lens at a smaller interference angle θ compared to FIG. 5a. Accordingly, the structure elements 15a of the interference pattern 15 according to FIG. 5b are arranged at a greater distance than in FIG. 5a; the structure period Λ is therefore greater in FIG. 5b than in FIG. 5a.

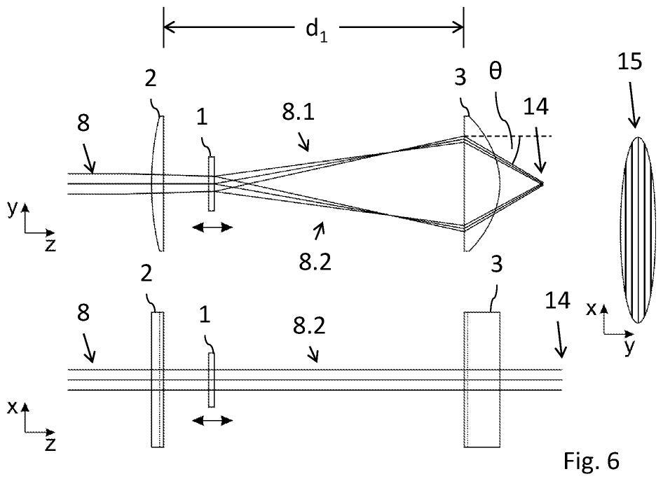

The embodiment in FIG. 6 is based on the embodiment in FIG. 5a, the second cylindrical lens 3 now being at a greater distance d₁ from the first cylindrical lens 2. For this purpose, the first cylindrical lens 2 and/or the second cylindrical lens 3 are movable in translation along the optical axis z. By increasing the distance d₁ between the first cylindrical lens 2 and the second cylindrical lens 3, both partial beams 8.1, 8.2 after the second cylindrical lens 3 are no longer collimated as in the embodiment in FIG. 5. Instead, they are now each refracted in a focused manner toward the interference region 14, similar to what has already been described in the embodiment in FIG. 4. The resulting interference pattern 15, shown schematically on the right in FIG. 6, has a smaller extension in the y-direction than the interference pattern 15 in FIG. 5a, because the changed arrangement of the cylindrical lenses 2, 3 provides a stronger focusing of the partial beams 8.1, 8.2 in the y-direction, but not in the x-direction. The structure period Λ of the interference pattern 15 of FIG. 6 is larger than that of FIG. 5a, but smaller than that of FIG. 5b.

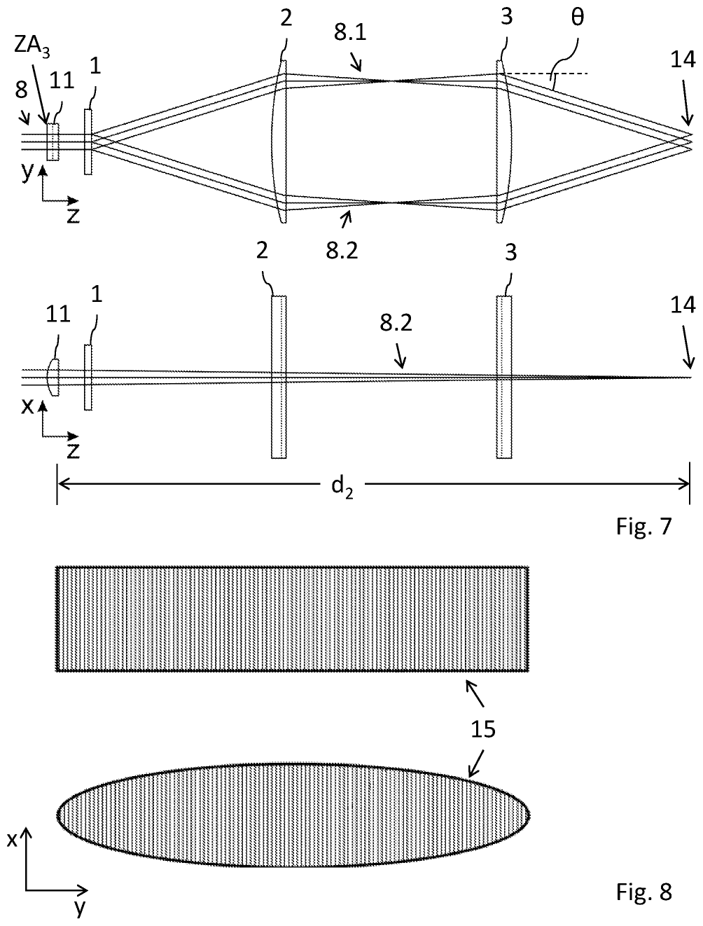

The embodiment in FIG. 7 corresponds to the embodiment in FIG. 1, a third cylindrical lens 11 now also being arranged in front of the beam splitter 1, the cylinder axis ZA₃ of said lens being oriented parallel to the y-axis, and thus perpendicular to the cylinder axes ZA₁, ZA₂ of the first and second cylindrical lenses 2, 3. In this respect, the third cylindrical lens 11 in the yz plane shown in the upper part of FIG. 7 has no significant influence on the beam path. In contrast, the third cylindrical lens 11 effects a focusing of the laser beam 8, including the partial beams 8.1, 8.2, in the xy plane, which is shown in the lower part of FIG. 7, the focal length of the third cylindrical lens 11 corresponding to the distance d₂ between the third cylindrical lens 11 and the interference region 14. Based on the focusing of the laser beam 8 in the xz plane, the interference patterns 15 obtained with this embodiment and shown in FIG. 8 each have a smaller extension in the x direction than the interference pattern of FIG. 3, the extensions in the y direction remaining unchanged and the structure period Λ not being influenced by the third cylindrical lens 11.

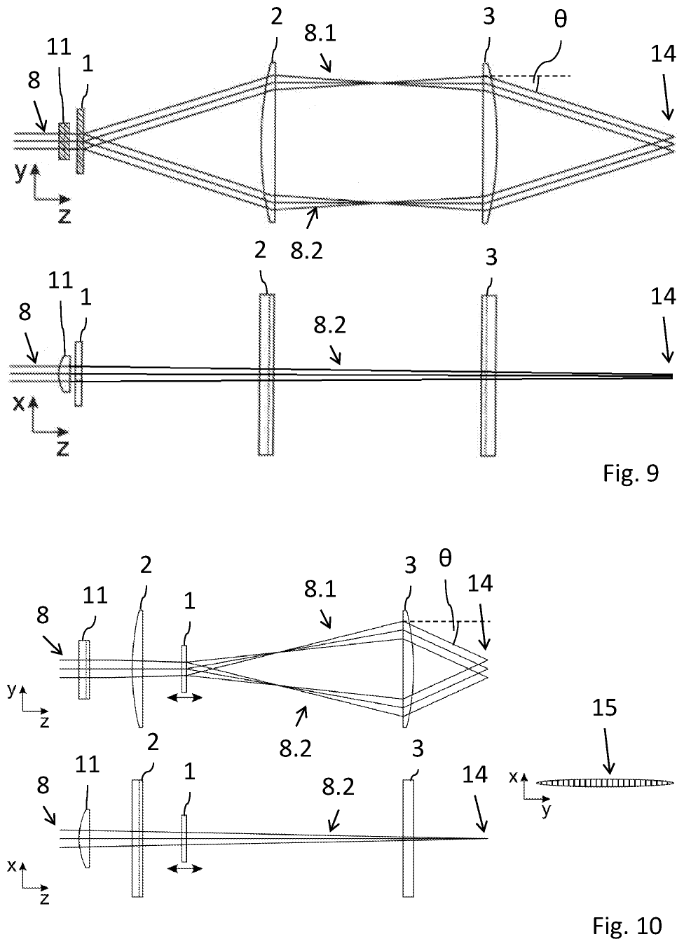

In the embodiment in FIG. 9, the third cylindrical lens 11 was moved, relative to the embodiment in FIG. 7, closer to the beam splitter 1 in a manner parallel to the optical axis z. As a result, the partial beams 8.1, 8.2 in the interference region 14 in the xz plane are no longer focused, as in the embodiment in FIG. 7, but instead have a larger spatial expansion, which is expressed in an interference region 14 accordingly enlarged in the x direction. The behavior of the beam path in the yz plane is not significantly influenced by the movement of the third cylindrical lens 11. In particular, the interference angle θ corresponds to that of the embodiment in FIG. 7.

Based on the embodiment in FIG. 7, the positions of the beam splitter 1 and the first cylindrical lens 2 may be switched, which is shown in the embodiment in FIG. 10. There, the laser beam 8, as it did before, hits the third cylindrical lens 11 first, but after that the first cylindrical lens 2 and then the beam splitter 1, which is movable along the optical axis z in order to alter the structure period Λ of the structure elements, as already described above. Compared to the interference pattern 15 of FIG. 8, the interference pattern 15 of FIG. 10 has a somewhat larger structure period Λ.

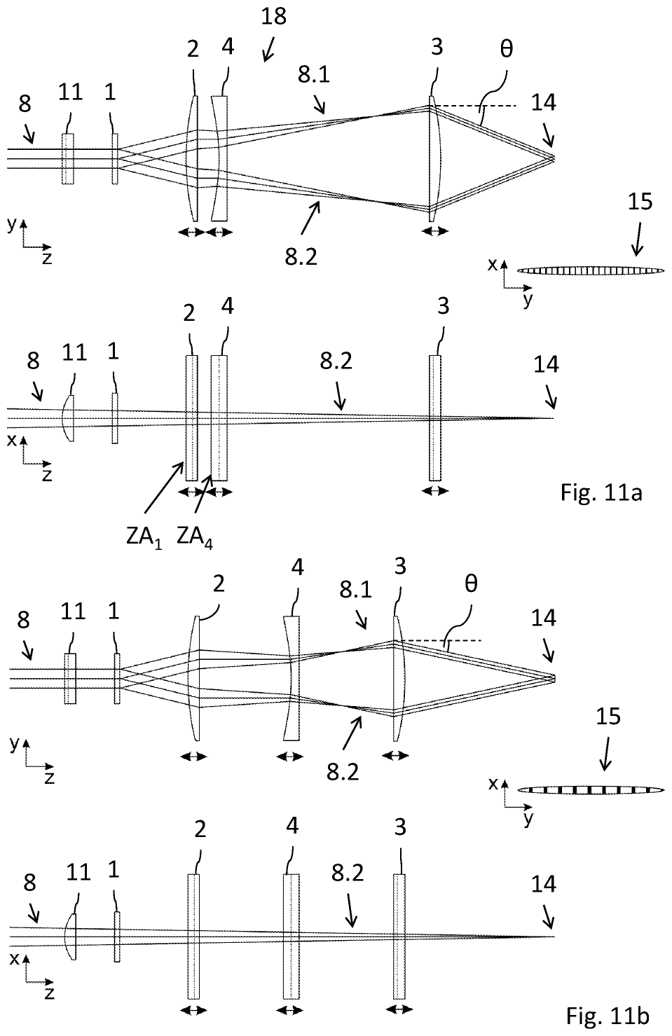

Based on the embodiment in FIG. 7, a fourth cylindrical lens 4 is additionally arranged between the first cylindrical lens 2 and the second cylindrical lens 3 in the embodiment in FIG. 11a. The cylinder axis ZA₄ of the fourth cylindrical lens 4 is aligned parallel to the x-axis and thus parallel to the cylinder axis ZA₁ of the first cylindrical lens 2. In the yz plane shown in the upper part of FIG. 11a, the fourth cylindrical lens 4 has a concave surface facing the beam splitter 1, while the surface facing away from the beam splitter 1 is planar. The fourth cylindrical lens 4 is therefore designed as a concave-planar diverging lens. After the fourth cylindrical lens 4, the two partial beams 8.1, 8.2 are each refracted away from the optical axis z, both partial beams 8.1, 8.2 then hitting the second cylindrical lens 3 in order to be refracted in the direction of the interference region 14. The combination of the first cylindrical lens 2, the fourth cylindrical lens 4, and the second cylindrical lens 3 corresponds functionally to a beam expander 18, the first cylindrical lens 2, the fourth cylindrical lens 4, and the second cylindrical lens 3 each being movable in translation and independently of one another along the optical axis z in order to influence the optical properties of the partial beams 8.1, 8.2, in particular the interference angle θ and thus also the structure period Λ of the interference pattern 15 shown on the right in FIG. 11a. In the xz plane shown in the lower part of FIG. 11a, the beam path of the embodiment substantially corresponds to that of FIG. 7, because the fourth cylindrical lens 4 does not significantly optically influence the beam path because of its biplanar configuration in the xz plane.

In FIG. 11b, the positions of the components of the beam splitter 18 have been changed relative to FIG. 11a: The first cylindrical lens 2 was moved in the direction of the beam splitter 1, and the fourth cylindrical lens 4 and the second cylindrical lens 2 were moved away from the beam splitter 1, the movements being synchronous with one another. As a result, the interference angle θ in FIG. 11b is reduced compared to that in FIG. 11a, which is expressed in a larger structure period Λ of the interference pattern 15 shown on the right in FIG. 11b.

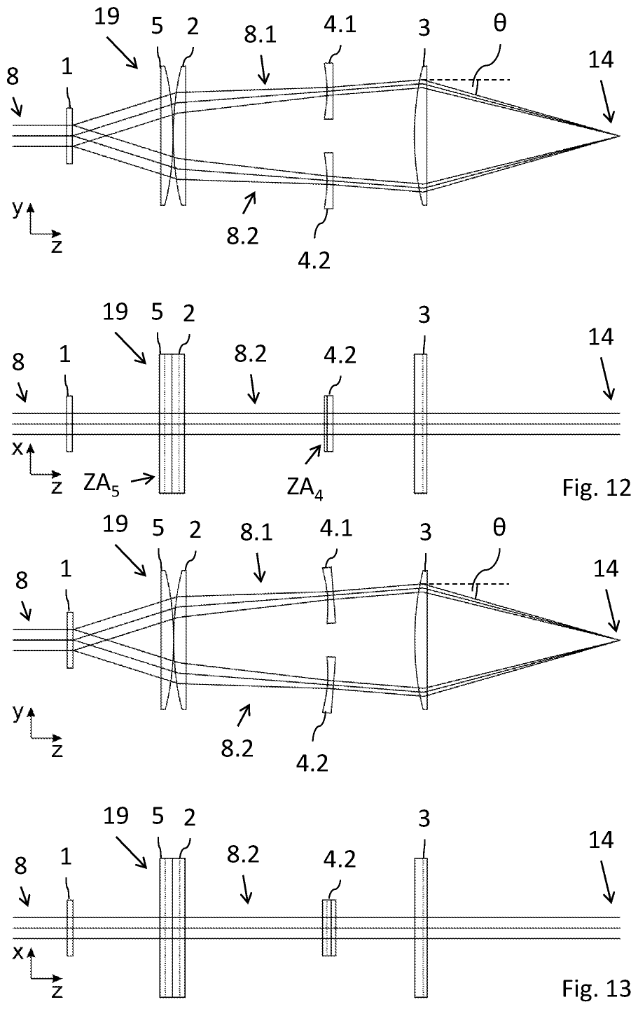

In the embodiment in FIG. 12, based on the embodiment in FIG. 1, a fifth cylindrical lens 5 is arranged as a converging lens immediately adjacent to and upstream of the first cylindrical lens 2, the convex surface of which faces the first cylindrical lens 2 and the cylinder axis ZA₅ of which is aligned parallel to the cylinder axis ZA₁ of the first cylindrical lens 2. The fifth cylindrical lens 5 together with the first cylindrical lens 2 forms a lens system 19, the fifth cylindrical lens 5 correcting in particular optical errors of the first cylindrical lens 2. Compared to the embodiment in FIG. 1, two fourth cylindrical lenses 4.1, 4.2 are also provided between the first cylindrical lens 2 and the second cylindrical lens 3, each being provided as diverging lenses in the beam path and the cylinder axes ZA₄ of which being aligned parallel to the x-axis and thus parallel to the cylinder axis ZA₁ of the first cylindrical lens 2. The two fourth cylindrical lenses 4.1, 4.2 are each configured concave-planar in the yz plane, are offset from one another in the y direction, and are each at the same distance from the first cylindrical lens 2 and the second cylindrical lens 3. By using the two fourth cylindrical lenses 4.1, 4.2, the partial beams 8.1, 8.2 may be adjusted independently of one another before the second cylindrical lens 3 refracts the two partial beams 8.1, 8.2 toward the interference region 14 in the manner already described. In the embodiment in FIG. 12, the first fourth cylindrical lens 4.1 is assigned to the first partial beam 8.1, and the second fourth cylindrical lens 4.2 is assigned to the second partial beam 8.2. In the xz plane shown in the lower part of FIG. 12, the two fourth cylindrical lenses 4.1, 4.2 are arranged one above the other and do not significantly influence the laser beam 8 because of their surfaces, which, consequently, are biplanar.

For the independent adjustment of the two partial beams 8.1, 8.2, the two fourth cylindrical lenses 4.1, 4.2 are each rotatable, in particular synchronously, parallel to the x-axis about their cylinder axes ZA₄. FIG. 13 shows the embodiment in FIG. 12 with the fourth cylindrical lenses 4.1, 4.2 rotated in this respect. In addition, the two fourth cylindrical lenses 4.1, 4.2 are each movable in translation independently of one another in the x, y, and/or z direction. Due to the movements of the fourth cylindrical lenses 4.1, 4.2, the positions of the partial beams 8.1, 8.2 focused on the sample 13 by the second cylindrical lens 3 may be adjusted independently of one another. As a result, incorrect adjustments may be compensated for, and the position of the interference pattern 15, in particular on the sample 13 and its extension in the x and y directions, may be influenced. In particular, with the embodiment in FIG. 12 and FIG. 13, a particularly small extension of the interference pattern 15 in the y-direction and a particularly small structure period Λ may be obtained. It is essential that the partial beams 8.1, 8.2 after the second cylindrical lens 3 each be refracted at the largest possible interference angle θ toward the interference region 14. For this purpose, in the embodiment in FIG. 12 and FIG. 13, the beam splitter 1 is movable in translation along the optical axis z.

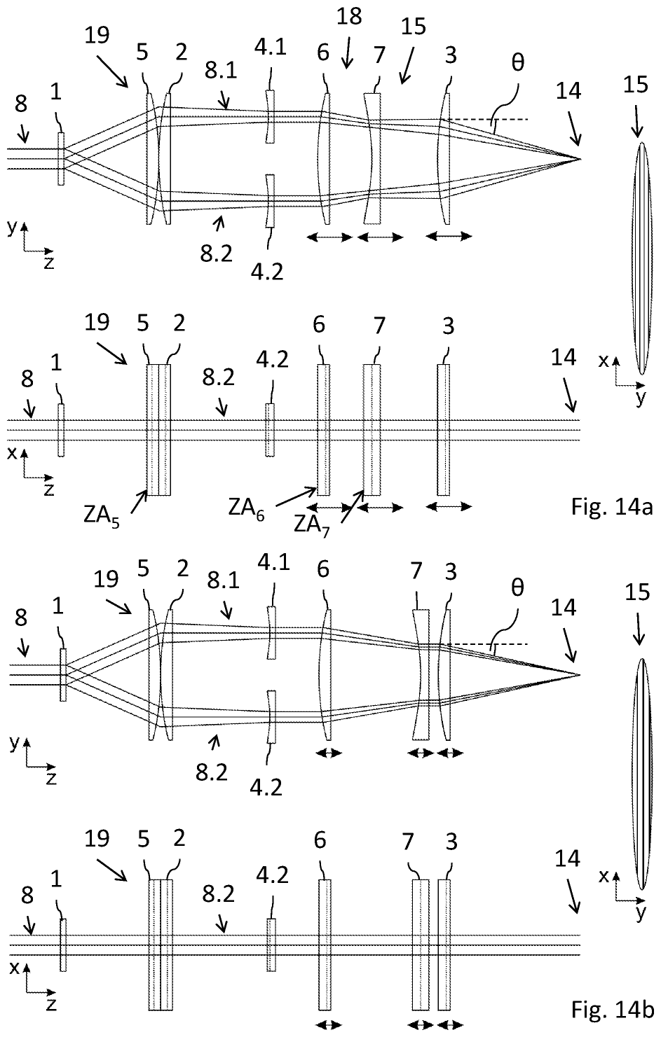

In the embodiment in FIG. 14a, compared to the embodiment in FIG. 12, a sixth cylindrical lens 6 is arranged as a converging lens and a seventh cylindrical lens 7 is arranged as a diverging lens in the beam path between the two fourth cylindrical lenses 4.1, 4.2 and the second cylindrical lens 3, the two cylinder axes ZA₆, ZA₇ of said sixth and seventh cylindrical lenses each being aligned parallel to the x-axis. The sixth cylindrical lens 6 is convex-planar in the yz plane and the seventh cylindrical lens 7 is concave-planar, the two planar surfaces each facing the second cylindrical lens 3. After passing through the two fourth cylindrical lenses 4.1, 4.2, the two partial beams 8.1, 8.2, each being collimated and aligned parallel to the optical axis z, hit the sixth cylindrical lens 6, through which the partial beams 8.1, 8.2 are focused in the direction of the optical axis z, the focal points each being arranged virtually behind the seventh cylindrical lens 7. Due to the concave-planar design of the seventh cylindrical lens 7, the partial beams 8.1, 8.2 are each refracted divergently in the direction of the third cylindrical lens 3, through which the partial beams 8.1, 8.2 are focused onto the interference region 14 at the interference angle θ in the manner already described. The sixth cylindrical lens 6, the seventh cylindrical lens 7 and the third cylindrical lens 3 are each displaceable in translation along the optical axis z and correspond functionally to a variable beam expander 18, the movements of the cylindrical lenses 6, 7, 3 along the optical axis z being able to change the structure period Λ of the interference pattern 15, the mobility of the components each being indicated by double arrows. In the embodiment in FIG. 14a, the beam splitter 1 effects a splitting of the laser beam 8 only in the y-direction. Because all cylinder axes ZA₁ to ZA₇ of the cylindrical lenses 2, 3, 4.1, 4.2, 5, 6, 7 are aligned parallel to the x-axis, the beam path in the xz plane shown in the lower region in FIG. 14 is not significantly influenced, while a relatively strong focusing occurs in the yz plane. Accordingly, the interference pattern 15 shown on the right in FIG. 14 is very narrow in the y-axis, while there is no significant influence in the x-direction.

In FIG. 14b, the positions of the sixth cylindrical lens 6, the seventh cylindrical lens 7 and the second cylindrical lens 3 have been changed in such a way that the partial beams 8.1, 8.2 are refracted at a smaller interference angle θ to the interference region compared to FIG. 14a, which manifests in a structure period Λ of the interference pattern 15 that is increased relative to FIG. 14a, its position and shape not being changed significantly.

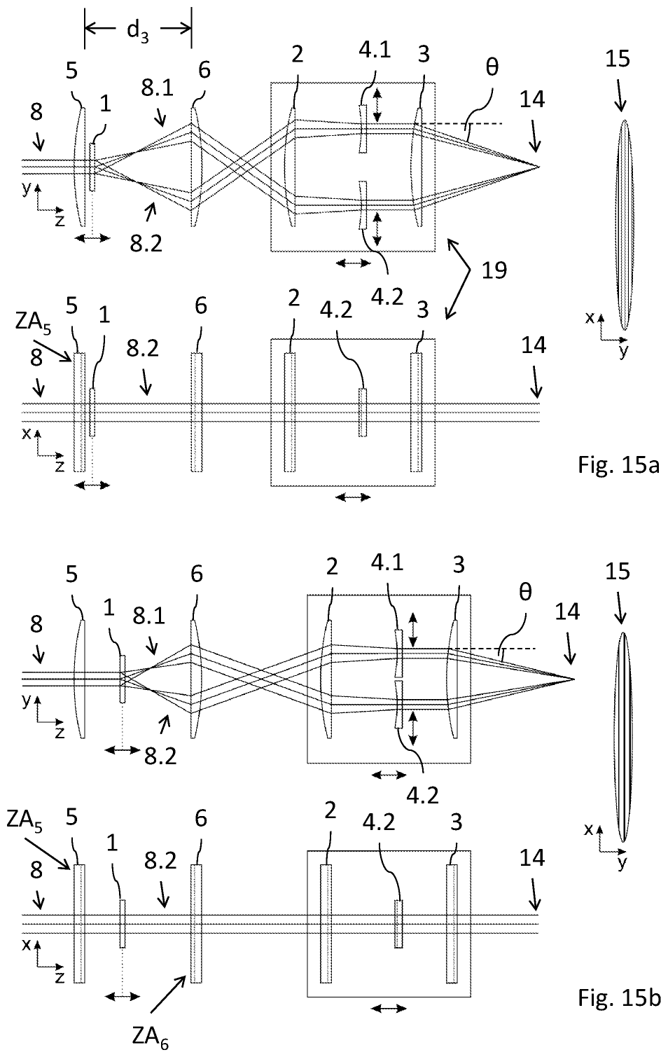

FIG. 15a shows an embodiment having a fifth cylindrical lens 5 arranged in front of the beam splitter 1 in the direction of the beam path as a converging lens, which lens is convex-planar in the yz plane shown in the upper region of FIG. 15a. The cylinder axis ZA₅ of the fifth cylindrical lens 5 is aligned parallel to the x-axis and thus parallel to the cylinder axis ZA₁ of the first cylindrical lens 2. Due to the fifth cylindrical lens 5, the collimated laser beam 8 incident on it is focused in the yz plane and directed onto the beam splitter 1, as a result of which the laser beam 8 is split into two partial beams 8.1, 8.2 in the manner already described. Due to the focusing by the fifth cylindrical lens 5, both partial beams 8.1, 8.2 are each focused on focal points which are arranged symmetrically with respect to the optical axis z. After passing through the focal points, the two partial beams 8.1, 8.2 each hit the sixth cylindrical lens 6 as a converging lens, the cylinder axis ZA₆ of which is aligned parallel to the cylinder axis ZA₁ of the first cylindrical lens 2 and which is plano-convex in the yz plane. The distance d₃ between the fifth cylindrical lens 5 and the sixth cylindrical lens 6 corresponds to the sum of both focal lengths, so that the partial beams 8.1, 8.2 are each collimated after passing through the sixth cylindrical lens 6. Because the partial beams 8.1, 8.2 hit the surface of the sixth cylindrical lens 6 at an angle, they are refracted at a finite angle relative to the optical axis z after passing through the sixth cylindrical lens 6, so that the partial beams 8.1, 8.2—each being collimated—cross one another and then hit the first cylindrical lens 2.

Due to the crossing of the two partial beams 8.1, 8.2, the first partial beam 8.1 is arranged at the bottom and the second partial beam 8.2 at the top after the sixth cylindrical lens 6 in FIG. 15a. After passing through the first cylindrical lens 2, the focal points of the two partial beams 8.1, 8.2 are each aligned parallel to the optical axis z. Similar to the embodiment in FIG. 12, two fourth cylindrical lenses 4.1, 4.2 are provided in the beam path after the first cylindrical lens 2, the first fourth cylindrical lens 4.1 in this case being assigned to the upper, second partial beam 8.2 and the second fourth cylindrical lens 4.2 being assigned to the lower, first partial beam 8.1. After passing the two fourth cylindrical lenses 4.1, 4.2, the two partial beams 8.1, 8.2 are each collimated and aligned parallel to the optical axis z and hit the second cylindrical lens 3, through which the two partial beams 8.1, 8.2 are refracted toward the interference region 14 in a known manner.

In FIG. 15a, the first cylindrical lens 2, the two fourth cylindrical lenses 4.1, 4.2 and the second cylindrical lens 3 together form a lens system 19 which is displaceable along the optical axis z, the relative positions of the components of the lens system 19 along the optical axis z not changing, so that the components of the lens system 19 are movable synchronously. In addition, the beam splitter 1 is movable in translation along the optical axis z in order to, together with a movement of the lens system 19, influence the structure period Λ in particular. The beam splitter 1 is arranged in FIG. 15b closer to the sixth cylindrical lens 6 than in FIG. 15a. In addition, the two fourth cylindrical lenses 4.1, 4.2 are movable in translation, in particular along the y-axis, in order to correct the positions of the partial beams 8.1, 8.2 in the interference region 14 and to compensate for adjustment errors, in particular in such a way that the partial beams 8.1, 8.2 after the fourth cylindrical lenses 4.1, 4.2 should always be collimated. In FIG. 15b, the two fourth cylindrical lenses 4.1, 4.2 have each been moved along the y-axis to the optical axis z, i.e., toward one another. The mobility of the components in translation is indicated in each case by a double arrow. Due to the movement of the components described above, the interference angle θ in FIG. 15b is smaller than in FIG. 15a, which is manifested in a correspondingly increased structure period Λ of the interference pattern 15. Because all cylinder axes ZA₁ to ZA₆ of the cylindrical lenses 2, 3, 4.1, 4.2, 5, 6 are aligned parallel to one another in the embodiment in FIG. 15a, the laser beam 8, including its partial beams 8.1, 8.2, is not significantly optically influenced in the xz plane shown in FIG. 15a below, which also applies to the movement of the components that may be seen in FIG. 15b.

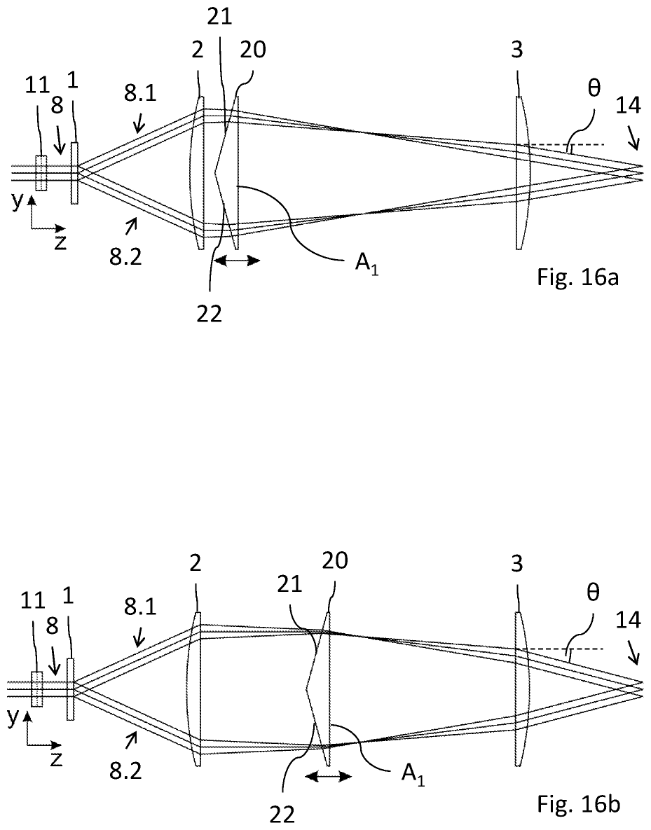

The embodiment in FIG. 16a is a development of the embodiment shown in FIG. 7, a first prism 20 being additionally arranged between the first cylindrical lens 2 and the second cylindrical lens 3. The first prism 20 has an isosceles triangle as its base area A₁, both legs 21, 22 facing the beam splitter 1. The prism axis PA₁ of the first prism 20, which is arranged normal to the base area A₁, is aligned parallel to the x-axis. The first prism 20 is arranged closer to the first cylindrical lens 2 than to the second cylindrical lens 3, so that the focal points of the partial beams 8.1, 8.2 are each between the first prism 20 and the second cylindrical lens 3. Due to the surfaces of its legs 21, 22 which are inclined in relation to the partial beams 8.1, 8.2, the first prism 20 causes focusing—in the yz plane—of the partial beams 8.1, 8.2 so that, as already described, the path difference between the partial beams 8.1, 8.2 is kept as small as possible. In addition, the first prism 20 is movable in translation along the optical axis z, so that the structure period Λ of the interference pattern 15 is changeable. In contrast to FIG. 16a, the first prism 20 in FIG. 16b was moved in the direction of the second cylindrical lens 3, which results in a reduction of the interference angle θ and, thus, an increase in the structure period Λ of the interference pattern 15. In addition, the first prism 20 may be rotated 180° about the x-axis, so that the legs 21, 22 of the first prism 20 face the second cylindrical lens 3. Because of the arrangement, the first prism 20 does not significantly affect the beam path in the xz plane, which substantially corresponds to the beam path shown in FIG. 7.

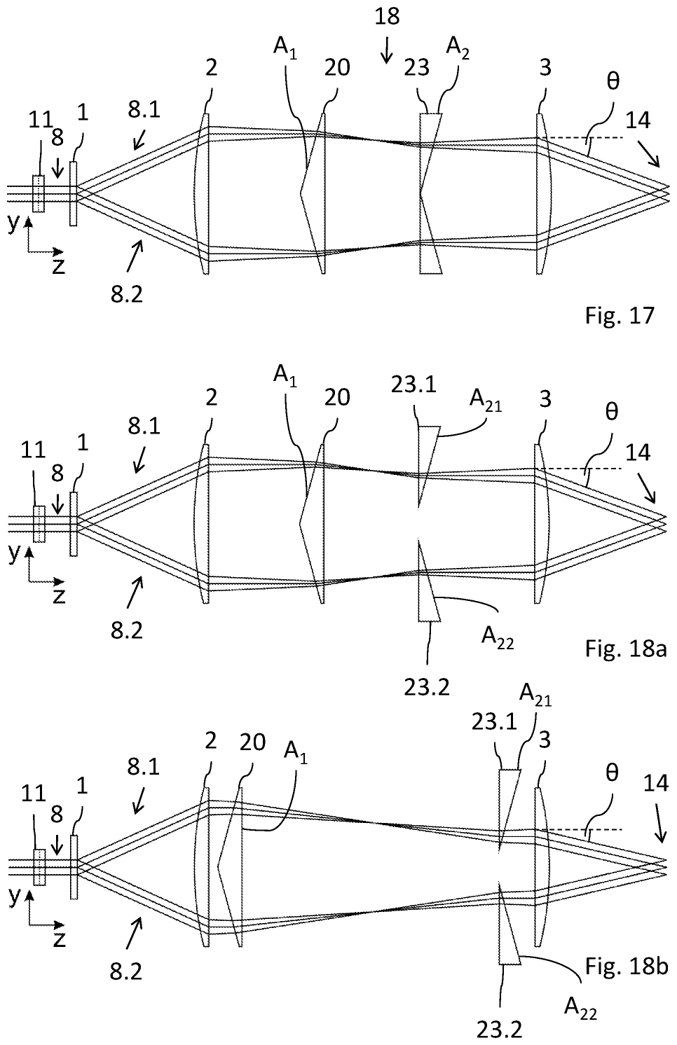

Based on the embodiment in FIGS. 16a and 16b, a second prism 23 is arranged in the embodiment shown in FIG. 17 in the beam path between the first prism 20 and the second cylindrical lens 3, in particular after the focal points of the partial beams 8.1, 8.2. The base area A₂ of the second prism 23 corresponds to two joined triangles, each a right triangle whose catheti, which are arranged parallel to one another and are connected to one another, are each arranged parallel to the y-axis. The prism axis PA₂ of the second prism 23 is arranged parallel to the x-axis. Due to its arrangement and configuration, the second prism 23 effects a divergence of the partial beams 8.1, 8.2 passing through it. The first prism 20 and the second prism 23 are each movable in translation along the optical axis z and, together with the third cylindrical lens 3, represent a variable beam expander 18 in this embodiment via which the structure period Λ of the interference pattern 15 is changeable, in particular by changing the interference angle θ. If only the second prism 23 is moved in translation parallel to the optical axis z, the interference angle becomes θ, and thus the structure period Λ is changed, but not the spatial position of the interference region 14.

The second prism 23 may be replaced by two—separate—second prisms 23.1, 23.1, which are each movable in translation parallel to the optical axis z, which is shown in the embodiment in FIG. 18a. The two second prisms 23.1, 23.2 are designed and arranged symmetrically to the optical axis z. The two second prisms 23.1, 23.2 each have a right triangle as the base area A₂₁, A₂₂, the prism axes PA₂₁, PA₂₂ of the two prisms 23.1, 23.2 being arranged parallel to the x-axis. Alternatively, instead of the two second prisms 23.1, 23.2, two wedge plates may also be provided in a corresponding configuration. The first second prism 23.1 is assigned to the first partial beam 8.1 and the second second prism 23.2 to the second partial beam 8.2. In FIG. 18b, starting from FIG. 18a, the first prism 20 was moved along the optical axis z toward the first cylindrical lens 2 and the two second prisms 23.1, 23.2 toward the second cylindrical lens 3, so that the interference angle θ in FIG. 18b is reduced compared to that of FIG. 18a.

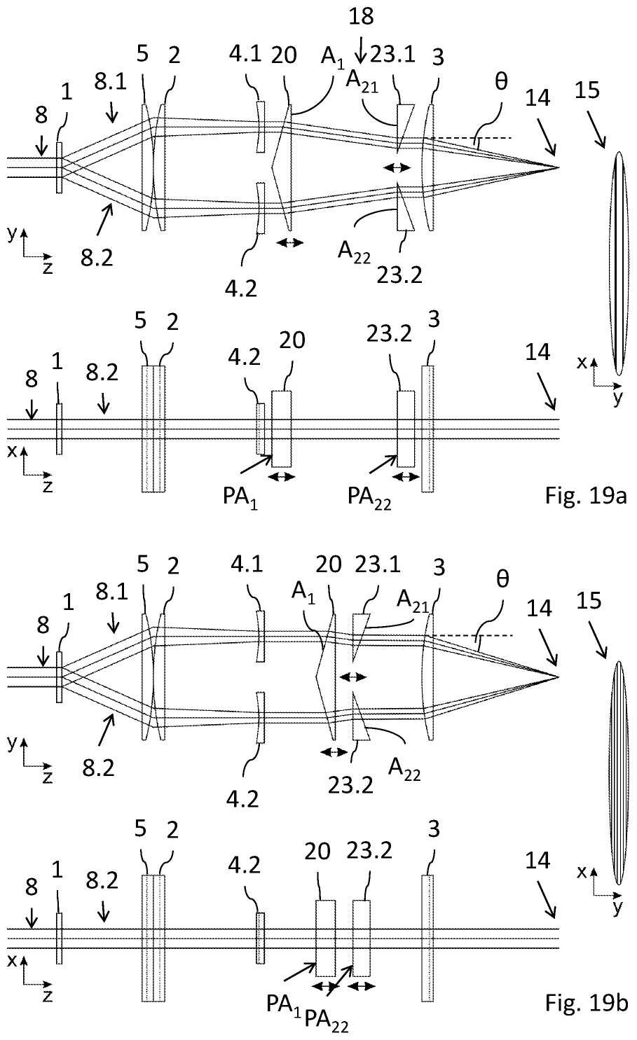

In the embodiment in FIG. 19a, based on the embodiment in FIG. 14b the sixth cylindrical lens 6 was replaced by the first prism 20 and the seventh cylindrical lens 7 was replaced by the two second prisms 23.1, 23.2, the first prism 20 and the two second prisms 23.1, 23.2 still being movable in translation, as before, along the optical axis z and, together with the third cylindrical lens 3, forming a variable beam expander 18, as already described. Based on its geometry, the first prism 20 has the same optical effect as the sixth cylindrical lens 6; the same applies to the two second prisms 23.1, 23.2 in relation to the seventh cylindrical lens 7. The beam path in FIG. 19a thus corresponds to that in FIG. 14b, as a result of which the interference patterns 15 obtained in each case are identical.

In FIG. 19b, the first prism 20 and the two second prisms 23.1, 23.2 were moved, starting from FIG. 19a, toward one another along the optical axis z, thereby increasing the interference angle θ and thus also reducing the structure period of the interference pattern 15.

FIG. 20 shows the embodiment in FIG. 1 with a laser 12 as the beam source, which, as a diode-pumped solid-state laser, emits the collimated, pulsed laser radiation shown in FIG. 1 with a pulse duration in the fs range. A sample 13 is arranged on the right-hand side of FIG. 20 in the previously described interference region 14 of the partial beams 8.1, 8.2 in such a way that its surface is provided with a structure 9 in accordance with the interference structure 15 shown in FIG. 3. The method according to the invention may be carried out by the above-described arrangement of the optical components of the optical device according to the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An optical device for interference structuring of a sample, the optical device comprising:
a laser to emit a laser beam;
a beam splitter to split the laser beam into at least two partial beams;
at least one first cylindrical lens;
at least one second cylindrical lens to refract the at least two partial beams in the direction of an interference region; and
at least one third cylindrical lens provided as a converging lens,
wherein the beam splitter, the at least first cylindrical lens, and the at least one second cylindrical lens are arranged in a beam path of the laser beam such that the at least two partial beams of the laser beam interfere with one another in the interference region such that a structure having linear structural elements is adapted to be formed in the structural region of the sample, and
wherein a cylinder axis of the at least one first cylindrical lens is aligned substantially parallel to the cylinder axis of the at least one second cylindrical lens, and
wherein the cylinder axis of the at least one third cylindrical lens is oriented substantially perpendicular to the cylinder axis of the at least one cylindrical lens and substantially perpendicular to the optical axis.

2. The optical device according to claim 1, wherein the at least one third cylindrical lens is arranged upstream and/or downstream of the beam splitter, and/or wherein the distance between the interference region and the at least one third cylindrical lens substantially corresponds to the focal length thereof.

3. The optical device according to claim 1, wherein at least one fourth cylindrical lens is provided as a diverging lens, wherein the cylinder axis of the at least one fourth cylindrical lens is arranged substantially parallel to the cylinder axis of the at least one first cylindrical lens and/or wherein the at least one fourth cylindrical lens is arranged downstream of the at least one first cylindrical lens.

4. The optical device according to claim 3, wherein the at least one fourth cylindrical lens is movable in translation in at least one axis and/or in rotation about its cylinder axis, and/or wherein exactly one fourth cylinder axis is assigned to each partial beam, and/or wherein at least two cylindrical lenses are movable independently of one another or synchronously with one another.

5. The optical device according to claim 1, wherein at least one fifth cylindrical lens is provided as a converging lens, the cylinder axis of which is aligned parallel to the cylinder axis of the at least one first cylindrical lens, and which, together with the at least one first cylindrical lens, forms a lens system, and/or wherein at least one sixth cylindrical lens is provided as a converging lens, the cylinder axis of which is aligned parallel to the cylinder axis of the at least one first cylindrical lens, and which is arranged upstream of the at least one second cylindrical lens, and/or wherein at least one seventh cylindrical lens is provided as a diverging lens, the cylinder axis of which is aligned parallel to the cylinder axis of the at least one first cylindrical lens, and which is arranged upstream of the at least one second cylindrical lens, wherein the at least one first cylindrical lens, together with the at least one second cylindrical lens and with the at least one fourth cylindrical lens and/or the at least one seventh cylindrical lens, together with the at least one second cylindrical lens and the at least one sixth cylindrical lens, in each case form a lens system.

6. The optical device according to claim 1, further comprising at least one first prism, a prism axis of which is aligned substantially parallel to the cylinder axis of the at least one first cylindrical lens, wherein a surface of the at least one first prism is aligned normal to the optical axis and/or further comprising at least one second prism, a prism axis of which is aligned substantially parallel to the cylinder axis of the at least one first cylindrical lens, wherein a base surface of the at least one second prism together with a base surface of the at least one first prism corresponds to a rectangle.

7. The optical device according to claim 6, wherein at least two second prisms are movable independently of one another, and/or in wherein the at least one first prism and/or the at least one second prism are arranged between the at least one first cylindrical lens and the at least one second cylindrical lens.

8. The optical device according to claim 1, wherein the beam splitter and/or at least one cylindrical lens and/or at least one prism are movable in translation parallel to the optical axis, and/or wherein at least one beam expander is provided for altering the beam cross section of the laser beam and/or for altering the structure periods, wherein the at least one beam expander is formed by three cylindrical lenses and/or by one cylindrical lens having a first prism and having at least one second prism.

9. The optical device according to claim 1, wherein the interference region comprises an interference pattern having linear structure elements, wherein the interference pattern (has a user-defined structure period that is changeable in at least one direction.

10. The optical device according to claim 1, wherein a beam forming device is provided which is configured such that the cross-sectional profile of the laser beam is changeable in a user-defined manner, wherein the beam forming device is designed for forming an elliptical or polygonal cross-sectional profile of the laser beam.

11. A method for interference structuring of a sample, the method comprising:
providing the optical device according to claim 1;
using the laser to emit a laser beam;
splitting the laser beam into the at least two partial beams;
arranging the at least one first cylindrical lens;
arranging at least one second cylindrical lens such that the at least two partial beams are refracted in a direction of an interference region such that the at least two partial beams of the laser beam interfere with one another in the interference region such that a structure having linear structural elements is adapted to be formed in a structural region of the sample; and
aligning a cylinder axis of the at least one first cylindrical lens substantially parallel to the cylinder axis of the at least one second cylindrical lens.

12. The optical device according to claim 1, wherein the optical device performs interference structuring of a sample or of a component.
